(19) United States
(12) Patent Application Publication
(10) Pub. No.: US 2009/0108231 A1
(43) Pub. Date: Apr. 30, 2009

(54) Surface preparation compound

(76) Inventor: Bo H. Gimvang, South Daytona, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/288,744

(22) Filed: Oct. 23, 2008

Related U.S. Application Data
(60) Provisional application No. 60/983,151, filed on Oct. 26, 2007.
(60) Provisional application No. 61/039,785, filed on Mar. 26, 2008.
(60) Provisional application No. 61/040,407, filed on Mar. 28, 2008.
(60) Provisional application No. 61/046,362, filed on Apr. 18, 2008.

(51) Int. Cl. C09K 13/04; C09K 13/00

(52) U.S. Cl. 252/79.2; 252/79.1

(57) ABSTRACT

A surface cleaner and activation composition that leaves functional acid sites on the substrate, such as for example a composition consisting essentially of deionized water, an acid, such as for example glacial acetic acid or phosphoric acid, an alcohol, such as for example isopropyl or ethyl alcohol, and an adhesion promoter consisting of an aminofunctional silane, such as for example aminopropylaminoethylsilane or aminoethylaminopropyltrimethoxy.

This patent application claims the benefit of U.S. Provisional Patent Application Ser. No. 60/983,151, filed Oct. 26, 2007, U.S. Provisional Patent Application Ser. No. 61/039,785, filed Mar. 26, 2008, U.S. Provisional Patent Application Ser. No. 61/040,407, filed Mar. 28, 2008, and U.S. Provisional Patent Application Ser. No. 61/046,362, filed Apr. 18, 2008.

### BACKGROUND OF THE INVENTION

This invention relates generally to the field of surface or substrate preparation compounds or compositions that clean, etch and prepare a substrate to better receive a surface coating. In particular, the invention relates to such a surface preparation composition that also provides functional acid sites on the substrate surface to promote better adhesion of a surface coating.

Applying, adhering or bonding surface modifiers or coatings to various substrates and surfaces, such as for example metal, plastics, ceramics, concrete, wood, laminates and the like, is well known. The term surface modifier is generally applied to coatings that are less than 0.5 microns, and for purposes herein this disclosure, the term “coating” shall be used to cover any generally accepted thicknesses of surface modifiers and coatings. A basic example is the application of paint to a surface exposed to sun, rain, wind, etc. Another example of circumstances wherein coatings are frequently used is for surfaces that encounter degradation from continuous or frequent contact with moving objects or particles entrained in liquid or gas flows.

One critical factor in the effectiveness and useful life of a coating is the degree of adhesion between the coating and the substrate or surface. Increasing the degree of adhesion may be accomplished by advance surface preparation of the substrate and/or by applying an intermediate layer between the substrate and the coating. The surface preparation composition or intermediate layer is chosen to optimize adhesion between the particular coating and the particular substrate. A recently formulated coating composition, the subject of a co-pending patent application, that possesses highly desirable properties relative to corrosion resistance and abrasion resistance is a coating that is predominantly made up of one or more alkoxy siloxanes, preferably having an alkoxy silane composition of at least 70 wt %. While penetration and adhesion of this coating is good without significant surface preparation other than general cleaning of the surface, the penetration and adhesion is greatly improved when the substrate is pretreated with the surface preparation compound as disclosed herein.

It is an object of this invention to provide a substrate surface preparation compound or composition, often referred to a primer, that cleans, etches and provides functional acid sites for improved bonding of a coating that is composed predominantly of one or more alkoxy siloxanes. This object and additional objects not expressly stated will be apparent upon examination of the disclosure herein.

### SUMMARY OF THE INVENTION

The invention comprises a surface cleaner, etcher and activation composition that leaves functional acid sites on the substrate, such as for example a composition consisting essentially of deionized water, an acid, such as for example glacial acetic acid or phosphoric acid, an alcohol, such as for example isopropyl or ethyl alcohol, and an adhesion promoter consisting of an aminofunctional silane, such as for example aminopropylaminoethylsilane or aminoethylaminopropyltrimethoxy.

### DETAILED DESCRIPTION OF THE INVENTION

In general, the invention is a surface cleaner, etcher and activation composition that leaves functional acid sites on the substrate. The composition is especially effective with a coating containing one or more alkoxy siloxanes in an amount greater than approximately 70 wt %. The composition may be applied to various substrates, and is particularly beneficial on metal or organic, e.g., fiberglass, substrates.

The composition consists essentially of deionized water present in a range of approximately 60 to 80 wt %, an acid present in the range of approximately 3 to 10 wt %, such as for example glacial acetic acid or phosphoric acid, an alcohol present in the range of approximately 10 to 35 wt %, such as for example isopropyl alcohol or ethyl alcohol, and an adhesion promoter consisting of an aminofunctional silane present in a range of about 1 to 6 wt %, such as for example aminopropylaminoethylsilane or aminoethylaminopropyltrimethoxy. The composition containing glacial acetic acid is best for organic substrates, while the composition containing phosphoric acid is best for metal substrates.

In one embodiment the composition consists essentially of deionized water, glacial acetic acid, isopropyl alcohol and aminopropylaminoethylsilane. The aminopropylaminoethylsilane may be present in an amount up to approximately 6 wt %, but is preferably a lesser amount. A representative and non-limiting mixture of components may be approximately 75 wt % of the deionized water, approximately 5 wt % of glacial acetic acid, approximately 19 wt % of isopropyl alcohol and approximately 1 wt % of aminopropylaminoethylsilane. This formulation promotes better adhesion on organic substrates.

In another embodiment the composition consists essentially of deionized water, phosphoric acid, ethyl alcohol and aminoethylaminopropyltrimethoxy. The aminoethylaminopropyltrimethoxy may be present in an amount up to approximately 6 wt %, but is preferably a lesser amount. A representative and non-limiting mixture of components may be approximately 70 wt % of the deionized water, approximately 8 wt % of phosphoric acid, approximately 20 wt % of ethyl alcohol and approximately 2 wt % of aminoethylaminopropyltrimethoxy. This formulation promotes better adhesion on metal substrates.

As representative and non-limiting examples of the coating for which the invention is useful as a pre-coating surface preparation compound, the coating composition consists essentially of:

at least two alkoxy siloxanes, wherein said total amount of said alkoxy siloxanes in said composition is greater than approximately 70 wt %, and wherein said alkoxy siloxanes are chosen from the group of alkoxy siloxanes consisting of methyltrimethoxysilane, methyltriethoxysilane, methyltrimethoxysilane, ethyltriethoxysilane, isopropyl trimethoxysilane, isopropyl triethoxysilane, n-butyl trimethoxysilane, isobutyl trimethoxysilane, phenyl trimethoxysilane, n-phenylaminopropyl trimethoxysilane, 3-(meth)acryloxypropyl triethoxysilane, 3-aminopropyl triethoxysilane, 3-mercaptopropyl trimethoxysilane, polydiethoxysilane, and fluoropropyl triethoxysilane;

a hydrolysable catalyst, wherein said catalyst is chosen from the group of catalysts consisting of titanium alcoholates, titanium alkanols, titanium tetraisopropoxide, titanium tetrabutoxide, aluminum titanate, aluminum zirconate, magnesium aluminate, magnesium titanate, magnesium zirconate, tetrabutoxytitanate, and titanium isopropoxide;

an adhesion promoter, wherein said adhesion promoter is chosen from the group of adhesion promoters consisting of gamma-glycidolxylpropylsilane and gamma-methacryloxypropyltrimethoxysilane; and

a flow/leveling agent, wherein said flow/leveling agent is a dimethyl siloxane.

Preferably, the total amount of said catalyst in said composition is less than approximately 5.0 wt %; and wherein the total amount of said adhesion promoter in said composition is less than approximately 2.5 wt %; and wherein the total amount of said flow-leveling agent in said composition is less than approximately 1 wt %.

In another embodiment, the coating composition consists essentially of:

at least two alkoxy siloxanes, wherein said total amount of said alkoxy siloxanes in said composition is greater than approximately 70 wt %, and wherein said alkoxy siloxanes are chosen from the group of alkoxy siloxanes consisting of methyltrimethoxysilane, methyltriethoxysilane, ethyltrimethoxysilane, ethyltriethoxysilane, isopropyl trimethoxysilane, isopropyl triethoxysilane, n-butyl trimethoxysilane, isobutyl trimethoxysilane, phenyl trimethoxysilane, phenyl triethoxysilane, n-phenylaminopropyl trimethoxysilane, 3-(meth)acryloxypropyl triethoxysilane, 3-aminopropyl triethoxysilane, 3-mercaptopropyl trimethoxysilane, polydiethoxysilane, and fluoropropyl triethoxysilane;

an alcohol chosen from the group of alcohols consisting of isopropyl and ethyl alcohol;

a hydrolysable catalyst, wherein said catalyst is chosen from the group of catalysts consisting of the combination of deionized water, an acid chosen from the group of acids consisting of phosphoric acid, boric acid and glacial acetic acid; and a metal oxide chosen from the group of metal oxides consisting of zinc oxide, magnesium oxide and calcium oxide;

an adhesion promoter, wherein said adhesion promoter is chosen from the group of adhesion promoters consisting of gamma-glycidolxylpropylsilane and gamma-methacryloxypropyltrimethoxysilane; and

a flow/leveling agent, wherein said flow/leveling agent is a dimethyl siloxane.

To increase the adhesion of the coating compounds as described above to a substrate, the surface preparation compound is applied to the substrate, at ambient or elevated temperature, rinsed and then allowed to dry prior to application of the coating composition.

It is contemplated that equivalents and substitutions for certain elements and steps set forth above may be obvious to those of ordinary skill in the art, and therefore the true scope and definition of the invention is to be as set forth in the following claims.

I claim:

1. A surface cleaner and activation composition consisting essentially of deionized water, an acid, an alcohol and an adhesion promoter consisting of an aminofunctional silane.

2. The composition of claim 1, wherein said acid is chosen from the group of acids consisting of glacial acetic acid and phosphoric acid.

3. The composition of claim 1, wherein said alcohol is chosen from the group of alcohols consisting of isopropyl alcohol and ethyl alcohol.

4. The composition of claim 1, wherein said aminofunctional silane is chosen from the group of aminofunctional silanes consisting of aminopropylaminoethylsilane or aminoethylaminopropyltrimethoxy.

5. The composition of claim 2, wherein said alcohol is chosen from the group of alcohols consisting of isopropyl alcohol and ethyl alcohol.

6. The composition of claim 2, wherein said aminofunctional silane is chosen from the group of aminofunctional silanes consisting of aminopropylaminoethylsilane or aminoethylaminopropyltrimethoxy.

7. The composition of claim 3, wherein said aminofunctional silane is chosen from the group of aminofunctional silanes consisting of aminopropylaminoethylsilane or aminoethylaminopropyltrimethoxy.

8. The composition of claim 5, wherein said aminofunctional silane is chosen from the group of aminofunctional silanes consisting of aminopropylaminoethylsilane or aminoethylaminopropyltrimethoxy.

9. The composition of claim 6, wherein the total amount of said aminofunctional silane in said composition is less than approximately 6 wt %.

10. The composition of claim 7, wherein the total amount of said aminofunctional silane in said composition is less than approximately 6 wt %.

11. The composition of claim 8, wherein the total amount of said aminofunctional silane in said composition is less than approximately 6 wt %.

12. The composition of claim 1, wherein said deionized water is present in a range of approximately 60 to 80 wt %, said acid is present in the range of approximately 3 to 10 wt %, said alcohol is present in the range of approximately 10 to 35 wt %, and said aminofunctional silane is present in the range of approximately 1 to 6 wt %

13. The composition of claim 1, wherein the total amount of said deionized water in said composition is approximately 75 wt %, said acid is glacial acetic acid present in said composition at approximately 5 wt %, said alcohol is isopropyl alcohol present in said composition at approximately 19 wt %, and said aminofunctional silane is aminopropylaminoethylsilane present in said composition at approximately 1 wt %.

14. The composition of claim 1, wherein the total amount of said deionized water in said composition is approximately 70 wt %, said acid is phosporic acid present in said composition at approximately 8 wt %, said alcohol is ethyl alcohol present in said composition at approximately 20 wt %, and said aminofunctional silane is aminoethylaminopropyltrimethoxy present in said composition at approximately 2 wt %.
